(19) United States
(12) Patent Application Publication
(10) Pub. No.: US 2025/0216826 A1
(43) Pub. Date: Jul. 3, 2025

(54) ARTIFICIAL INTELLIGENCE CHATBOT FOR BUILDINGS

(71) Applicant: HONEYWELL INTERNATIONAL INC., Charlotte, NC (US)

(72) Inventors: Adam GIBSON, Nyon (CH); Anas KHAN, Atlanta, GA (US); Banuprakash BALAKRISHNA, Udupi (IN); Deepika SANDEEP, Bangalore (IN); Nimmagadla SNEHITA, Devarapalli (IN); Renil MENDEZ, Trivandrum (IN); Roshan VALDER, Atlanta, GA (US); Vishwanath GUPTA, Ranchi (IN); Siddhant Sharad GHUNGRUDKAR, Chandrapur (IN)

(21) Appl. No.: 19/006,995

(22) Filed: Dec. 31, 2024

(30) Foreign Application Priority Data
Jan. 3, 2024 (IN) 202411000378
Apr. 30, 2024 (IN) 202411034280

(51) Int. Cl. G05B 15/02; G06F 16/3329; H04L 51/02

(52) U.S. Cl. CPC G05B 15/02; G06F 16/33295; H04L 51/02

(57) ABSTRACT

A method and system for interacting with a building management system via a chatbot includes receiving a natural language query and processing it to identify tools and arguments needed to collect information from data sources associated with the building management system. The identified tools are executed with corresponding arguments to collect information from the data sources. The collected information and natural language query are submitted to a Large Language Model, which generates a natural language response based on the query and collected information.

### CROSS-REFERENCE TO RELATED APPLICATIONS

This application claims priority pursuant to 35 U.S.C. 119(a) to Indian Provisional Application No. 20/241,1000378 filed Jan. 3, 2024, and the benefit of Indian Provisional Application No. 20/241,1034280 filed Apr. 30, 2024, which applications are incorporated herein by reference in their entireties.

### TECHNICAL FIELD

The present disclosure relates generally to building systems, and more particularly to using a chatbot to interact with a building system.

### BACKGROUND

Building management systems, particularly in large facilities, can be complex and include a large number of building components. Building management system operators may be required to navigate through intricate menus and perform multiple steps on an operator console in order to execute commands on the building management system and/or access desired information from the building management system. This can pose difficulties for the operators, and can consume considerable time. What would be desirable are improved processes for a building management system operator to issue commands to the building management system and/or access desired information from the building management system. What would be desirable is an intelligent chatbot that can assist building management system operators, even novice building management system operators, to more efficiently and effectively interact with a building management system.

### SUMMARY

The present disclosure relates generally to building systems, and more particularly to using a chatbot to interact with a building system. An example may be found in a method for interacting with a building management system via a chatbot. The method includes receiving a natural language query via the chatbot. The natural language query is processed to identify one or more tools of a plurality of available tools, along with one or more arguments for each of the identified one or more tools, for collecting at least some information from one or more data sources associated with the building management system to formulate a response to the natural language query. Each of the plurality of available tools is configured to collect only certain information from the one or more data sources dictated by the corresponding tool and the corresponding one or more arguments. The identified one or more tools each with the corresponding identified one or more arguments are executed to collect the at least some information from the one or more data sources. The collected information along with the natural language query is submitted to a Large Language Model, which generates the response to the natural language query based at least in part on the natural language query and the information that was submitted by the one or more tools to the Large Language Model. The response is displayed via the chatbot.

Another example may be found in a chatbot system for interacting with a building management system. The chatbot system includes a user interface and one or more I/O ports for communicating with one or more data sources associated with the building management system and for communicating with a Large Language Model. The chatbot system includes a memory for storing a plurality of tools. Each of the plurality of tools are configured to collect only certain information from the one or more data sources dictated by the corresponding tool and one or more arguments. A controller is operatively coupled to the user interface, the memory and the one or more I/O ports. The controller is configured to receive a natural language query via the user interface and to process the natural language query to identify one or more tools of the plurality of tools, along with one or more arguments for each of the identified one or more tools, for collecting at least some information from the one or more data sources associated with the building management system to formulate a response to the natural language query. The controller is configured to execute the identified one or more tools each with the corresponding identified one or more arguments to request and receive the at least some information from the one or more data sources via one or more of the I/O ports. The controller is configured to send the collected information along with the natural language query to the Large Language Model via one or more of the I/O ports. The controller is configured to receive from the Large Language Model via one or more of the I/O ports the response to the natural language query based at least in part on the natural language query and the information sent to the Large Language Model, and to display the response on the user interface.

Another example may be found in a non-transitory computer readable medium storing instructions thereon. When the instructions are executed by one or more processors, the one or more processors are caused to receive a natural language query via a user interface. The one or more processors are caused to process the natural language query to identify one or more tools of a plurality of available tools, along with one or more arguments for each of the identified one or more tools, for collecting at least some information from one or more data sources associated with a building management system to formulate a response to the natural language query, where each of the plurality of available tools is configured to collect only certain information from the one or more data sources dictated by the corresponding tool and the corresponding one or more arguments. The one or more processors are caused to execute the identified one or more tools each with the corresponding identified one or more arguments to collect the at least some information from the one or more data sources. The one or more processors are caused to submit the collected information along with the natural language query to a Large Language Model. The one or more processors are caused to receive from the Large Language Model the response to the natural language query based at least in part on the natural language query and the information submitted to the Large Language Model. The one or more processors are caused to display the response via the user interface.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative chatbot system for interacting with a building management system;

FIG. 2 is a schematic block diagram showing an illustrative architecture for a chatbot system;

FIGS. 3A and 3B are flow diagrams that together show an illustrative method for interacting with a building management system via a chatbot;

FIG. 4 is a schematic example of how a natural language query may be processed;

FIG. 5 is a sample screenshot showing a natural language query concerning April utility costs of a particular building and the corresponding natural language answer as well as a follow up natural language query and corresponding natural language answer that may be generated by an illustrative chatbot system;

FIG. 6 is a sample screenshot showing a natural language query regarding energy consumption on a particular floor and the corresponding natural language answer;

FIG. 7 is a sample screenshot showing a natural language query regarding total energy consumption and the corresponding natural language answer;

FIG. 8 is a sample screenshot showing a natural language query regarding energy use by asset type and the corresponding natural language answer;

FIG. 9 is a sample screenshot showing a natural language query regarding battery installation and the corresponding natural language answer;

FIG. 10 is a sample screenshot showing a natural language query regarding installation steps and the corresponding natural language answer;

FIG. 11 is a sample screenshot showing a natural language query regarding environmental requirements and the corresponding natural language answer; and

FIG. 12 is a sample screenshot showing a natural language query regarding an oscillating control signal and the corresponding natural language answer.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

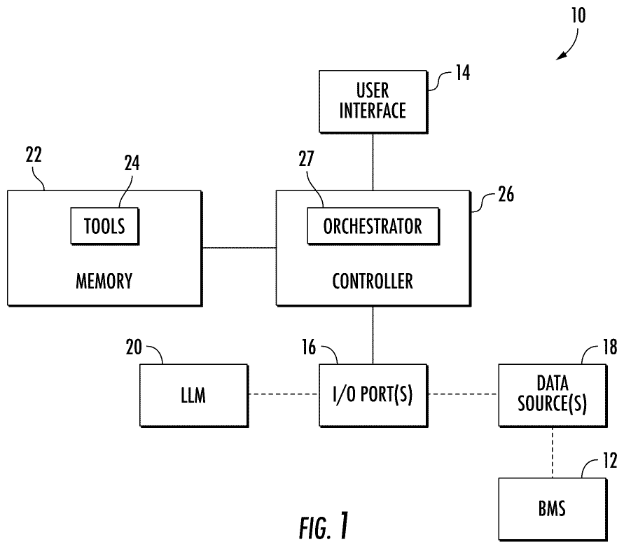

FIG. 1 is a schematic block diagram showing an illustrative chatbot system 10 that allows operators to interact with a building management system (BMS) 12. The BMS 12 may represent any of a variety of different types of building control systems. In some cases, the BMS 12 may represent, or may include, a Heating, Ventilating and Air Conditioning (HVAC) system. The BMS 12 may represent, or may include, a security system. The BMS 12 may represent, or may include, an access control system. The BMS 12 may represent, or may include, a lighting system. The BMS 12 may represent, or may include, a fire system. These are just examples.

The illustrative chatbot system 10 includes a user interface 14. In some cases, the user interface 14 may be part of a desktop or laptop computer and may include a display and data entry mechanisms such as a keyboard and a mouse. In some cases, the user interface 14 may include a tablet. In some cases, the user interface 14 may include a smartphone. The chatbot system 10 includes one or more I/O ports 16 for communicating with one or more data sources 18 that are associated with the BMS 12 and for communicating with a Large Language Model (LLM) 20. A memory 22 is configured to store a plurality of tools 24. In some cases, each of the plurality of tools 24 may be configured to collect only certain information from the one or more data sources 18 dictated by the corresponding tool and one or more arguments. The arguments may be derived from a natural language query entered into the user interface 14. A controller 26 is operatively coupled to the user interface 14, the memory 22 and the one or more I/O ports 16. In some cases, the controller 26 includes or is in communication with an orchestrator 27, which in some cases may include a Lang chain agent or the like.

The controller 26 is configured to receive a natural language query via the user interface 14 and to process the natural language query to identify one or more tools of the plurality of tools 24, along with one or more arguments for each of the identified one or more tools, for collecting at least some information from the one or more data sources 18 associated with the BMS 12 to formulate a response to the natural language query. The controller 26 is configured to execute the identified one or more tools each with the corresponding identified one or more arguments to request and receive the at least some information from the one or more data sources 18 via one or more of the I/O ports 16. The controller 26 is configured to send the collected information along with the natural language query to the LLM 20 via one or more of the I/O ports 16. The controller 26 is configured to receive from the LLM 20 via one or more of the I/O ports 16 the response to the natural language query based at least in part on the natural language query and the information sent to the LLM 20. The controller 26 is configured to display the response on the user interface 14.

In some cases, the controller 26 may be configured to process the natural language query and identify two or more tools of the plurality of tools 24, along with one or more arguments for each of the identified two or more tools. The identified two or more tools are each executed with the corresponding identified one or more arguments to request and receive the at least some information from the one or more data sources 18 via one or more of the I/O ports 16. In some cases, the one or more data sources 18 may include, for example, a utility usage data source representative of a utility usage of the BMS 12, and wherein the plurality of tools 24 may include a utility usage tool that is configured to collect utility usage information from the utility usage data source, and wherein the one or more arguments of the utility usage tool include one or more of a start data and an end date. In some cases, the utility usage data source may include a quantity of utility usage over time and a cost associated with the utility usage. The utility usage data source may include a quantity of utility usage of each of two or more assets of the BMS 12. The utility usage data source may include a quantity of utility usage of each of two or more zones of the BMS 12. The utility usage data source may include a quantity of carbon emissions associated with the utility usage of the BMS 12. These are just examples. In some cases, the controller 26 may be configured to submit the natural language query to the orchestrator 27. The orchestrator 27 may be configured to identify the one or more tools (e.g. the API's to access the one or more tools) along with the one or more arguments for each of the identified one or more tools.

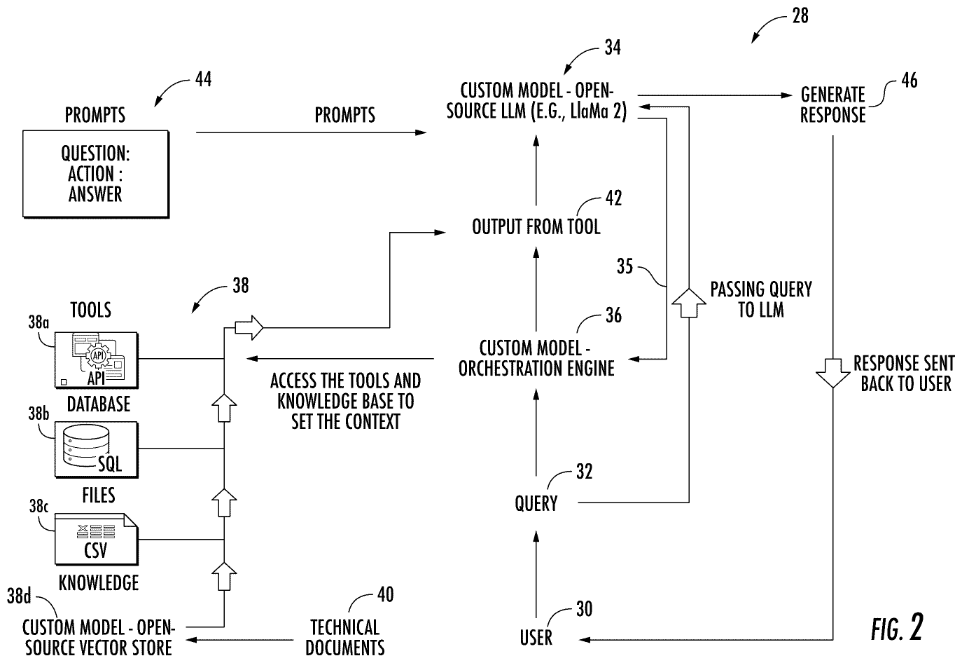

FIG. 2 is a schematic block diagram showing an illustrative architecture 28 for the illustrative chatbot 10. A user 30 provides a query 32. The query 32 may be a typed query such as a natural language text message. In some cases, the query 32 may be a verbal question that is captured and converted to text by a voice to text translator, for example. In some cases, the natural language query 32 may be a request for certain information regarding the operation of the building management system (e.g. energy usage). In some cases, the query 32 may be a question as to how to perform a particular step or process within the building management system, for example. In some cases, the query 32 may not be a question, but instead may be a command for the BMS 12 to perform an act or function. The natural language query 32 may provide an elegant way for the user 30 to issue a command to one or more BMS 12 devices without having to go through a myriad of menus, pull-down boxes and the like in order to issue a command to each BMS 12 device. These are just examples.

In the example shown, the query 32 may be passed to one or more elements within the chatbot 10. For example, the query 32 may be passed to an LLM 34 that may be considered an example of the LLM 34 shown in FIG. 1. Alternatively, or in addition, the query 32 may be passed to an orchestration engine 36 that may be considered as being an example of the orchestrator 17 shown in FIG. 1. In some cases, the orchestration engine 36 may be, or may include, a Lang chain agent.

In response to receiving the query 32, the LLM 34 may process the natural language query 32 and identify one or more descriptors of one or more BMS 12 devices that are a subject of the natural language query 32, and to identify a desired result of the natural language query 32. The LLM 34 may derive a context of the query 32 based on the query 32 itself and in some cases based on prior queries 32 of the user 30. The LLM 34 may report the one or more descriptors of one or more BMS 12 devices that are a subject of the natural language query 32 and the desired result of the natural language query 32 to the orchestration engine 36, as shown at 35. In some cases, the orchestration engine 36 itself may be equipped to processes the natural language query 32, identify one or more descriptors of one or more BMS 12 devices that are a subject of the natural language query 32, and identify a desired result of the natural language query 32, without invoking the LLM 34.

In the example shown, the orchestration engine 36 communicates with a number of tools 38, sometimes through corresponding APIs (Application Programming Interfaces). The tools are configured to access one or more databases 38a, files 38b, knowledge bases 38c and/or open source vector stores 38d. The open source vector store 38d may vectorize knowledge extracted from technical documents 40 for easy vector searching of that knowledge via a vector-based search engine. The technical documents 40 may contain, among other things, local knowledge relevant to the particular BMS 12 system. The orchestration engine 36 identifies the most suitable tool(s) 38 needed to collect relevant information from the external systems (i.e. the BMS system) to formulate a response to the query 32. For example, the orchestration engine 36 may make requests to the tools to obtain particular information and/or to control one or more building control devices in response to the natural language query 32, as indicated by the output from tool block 42. In the example shown, the LLM 34 receives the output from the tool 42, along with the natural language query 32, and formulates a natural language response 46. The natural language response 46 may be a combination of the LLM's understanding, the data from external systems (e.g. data from the tools 42), and the initial query's context. The natural language response 46 may be provided back to the user 30 as shown. In some cases, this may result in the user 30 providing a subsequent query 32 in order to more closely find the information they are looking for, or to more precisely state a desired result they wish to achieve (e.g. lock all doors on the east and west entrances).

In some cases, example tools 38 may additionally or alternatively include, for example:
1. A Utility Bill Tool: provides detailed site utility bill data for a specified request period of time. Requires start date, end date, and a flag to indicate if a plot is needed.
2. A Portfolio Utility Data Tool: Retrieves consumption, savings, and cost information at the portfolio or organization level for a specified period. Requires start date, end date, and a flag to indicate if a plot is needed.
3. A Building Performance Tool: Provides information related to the performance of a building, such as Energy Usage Intensity (EUI) and site building area details. Requires a reference date.
4. A Floor Energy Consumption Tool: Provides information on floor-level energy consumption. Requires start date and end date.
5. An Asset Energy Consumption Tool: Provides information on asset-level total energy consumption for a given period in a site. Requires start date and end date.
6. A Site Energy Consumption Tool: Provides information on site-level total energy consumption for a given period. Requires start date and end date.
7. A Site Carbon Emission Tool: Provides information on site-level carbon emissions for a given period. Requires start date, end date, and a flag to indicate if a plot is needed.
8. A Portfolio Carbon Emission Tool: Provides information on portfolio-level carbon emissions for a given period. Requires start date, end date, and a flag to indicate if a plot is needed.
9. A Chart Gen Tool: Used to generate a chart. Requires a string of Matplotlib code to be executed.
10. A Portfolio Building Performance Tool: Provides information related to the performance of a portfolio's buildings, such as Energy Usage Intensity (EUI) and site building area details. Requires a reference date.
11. A Site Utility Breakdown Tool: Provides a detailed breakdown of utility usage at a site for a specified period. Requires start date and end date.

Once the relevant information is collected from the external systems (BMS, Utilities, etc.) by the identified tools (e.g. via APIs), the orchestration engine 36 (e.g. a Lang chain agent) prepares the collected data along with the original user query and an associated prefix prompt, for submission to the LLM input. The prefix may provide context for the query and the collected data to the LLM. Example prefix text may include:
You are a laconic assistant for a building manager dashboard.
You reply with brief, to-the-point answers with no elaboration pertaining only to buildings and sustainability.
For any query that does not relate to buildings or sustainability respond with: “Apologies! I can only answer queries related to buildings and sustainability” The current date is (Current Date Here). Use this date when asked questions about relative dates like this year, last month, last 6 months and similar. When a question includes just a month with no year then assume the year is (current Year here).
Adhere to the following guidelines when responding to user queries:
   1) By default, if no specific date is mentioned in the query, the system will retrieve data from the past three months.
   2) When providing recommendations for utility information, it is crucial to include the following point in the response:
      If the user inquires about comparing the energy consumption reported in the utility bill (via the utility_bill API) with the building's energy consumption (via the building_performance API) and identifies a discrepancy, the following recommendations can be provided: “You should consider sub-metering or utilizing NILM, or if you have other metering systems not connected to HBSM, please work with the Honeywell team to make these visible in HBSM.”
   3) It is mandatory to adhere to the following syntax for specifying start and end dates: The start date should always be the first day of the month, while the end date should be the last day of the month. For example, if you inquire about “what is my energy consumption for the month of May,” the start date should be 2023 May 1 and the end date should be 2023May 31.
   4) When considering energy consumption across various assets, if the ‘HVAC’ energy consumption comes to be highest among other assets/equipments, you must add below statement/recommendation in your answer: “You may want to switch to ECMs like IBO to optimize your HVAC energy consumption.” Similarly if the ‘Lighting’ energy consumption comes to be highest, recommend following in your answer: “You may want to switch to ECMs like Lightning optimization to reduce your energy consumption”.
      Example: Which equipment consumed most energy in month of April?
      Thought: Since HVAC consumed most among other assets, I will recommend user to opt ‘IBO solution’.
      Response: “HVAC consumed most energy in April 2023 (30290.50904 kilowatt hour). You may want to switch to ECMs like IBO to optimize your HVAC energy consumption.”
   5) If I am unable to determine the appropriate function or tool to use, I will respond by stating that I currently lack the capability to offer a solution to the question without asking the user for suggestions.
   6) As an AI language model, I can also provide information on hypothetical scenarios in addition to relying on historical data. My function is to offer insights and generate responses based on a mixture of both historical information and the context provided to me. Please feel free to ask any hypothetical questions or request information within a given scenario, and I'll do my best to assist you!
   7) When handling site-specific queries from the portfolio, if the mentioned site is not detected in the function call response, make sure to incorporate the phrase “The indicated site is not present in the portfolio” in your reply.
   8) Do not answer any kind of general knowledge questions.
   9) Remember Only use the functions you have been provided with.
   10) Previous_conversation_history:

### (History Here)

Refer to the Previous_conversation_history to understand the ongoing context. Then, help me generate a response that takes that context into consideration. It's important that the response is coherent and informed by the prior discussion.
As we continue our conversation, remember to look back at the previous discussion. This will help you maintain a consistent understanding of the topic and enable you to provide well-informed and contextually relevant answers.

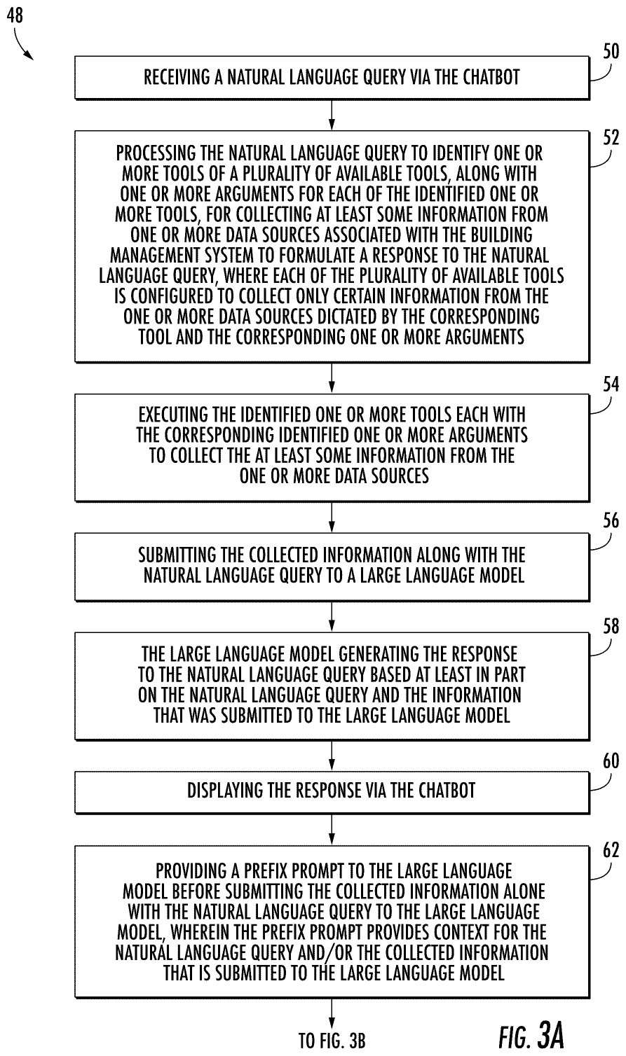

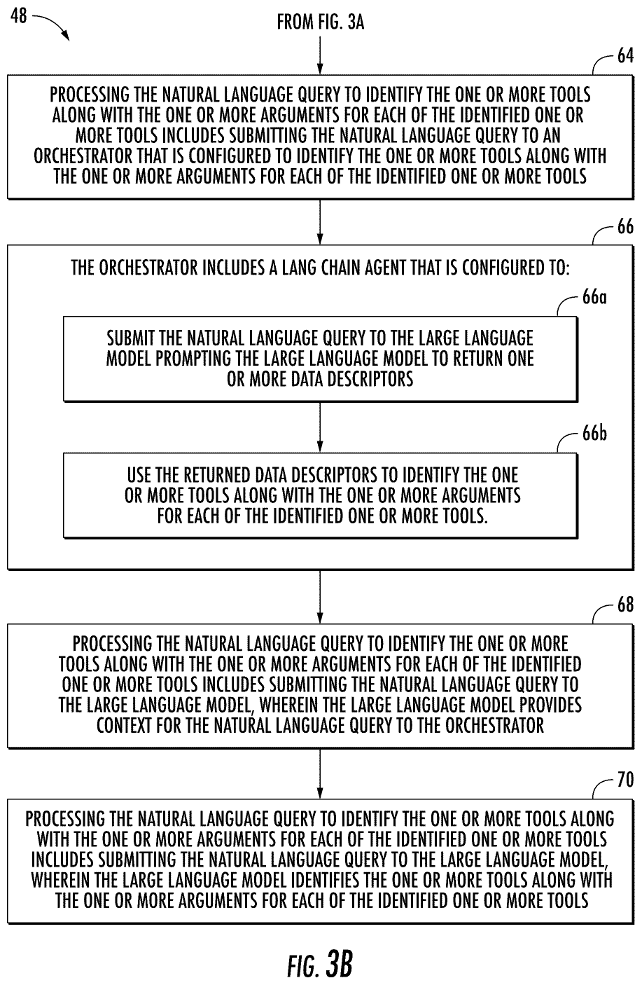

FIGS. 3A and 3B are flow diagrams that together show an illustrative method 48 for interacting with a building management system (such as the BMS 12) via a chatbot. The illustrative method includes receiving a natural language query via the chatbot, as indicated at block 50. The natural language query is processed to identify one or more tools of a plurality of available tools, along with one or more arguments for each of the identified one or more tools, for collecting at least some information from one or more data sources associated with the building management system to formulate a response to the natural language query, where each of the plurality of available tools is configured to collect only certain information from the one or more data sources dictated by the corresponding tool and the corresponding one or more arguments, as indicated at block 52. In some cases, each of the identified one or more tools may include an Application Programming Interface (API) that is configured to access one or more corresponding data sources of the one or more data sources. Executing the identified one or more tools may include submitting each of the corresponding identified one or more arguments to the one or more corresponding data sources via the corresponding API, and in response collecting the at least some information via the corresponding API.

In some cases, processing the natural language query may identify two or more tools of the plurality of available tools, along with one or more arguments for each of the identified two or more tools, and wherein the identified two or more tools are each executed with the corresponding identified one or more arguments to collect the at least some information from the one or more data sources to formulate the response to the natural language query. In some cases, the one or more data sources may include a utility usage data source representative of a utility usage of the building management system and the plurality of available tools may include a utility usage tool that is configured to collect utility usage information from the utility usage data source, and wherein the one or more arguments of the utility usage tool include one or more of a start data and an end date. In some cases, the utility usage data source may include a quantity of utility usage over time and a cost associated with the utility usage. In some cases, the utility usage data source may include a quantity of utility usage of each of two or more assets of the building management system. In some cases, the utility usage data source may include a quantity of utility usage of each of two or more zones of the building management system. In some cases, the utility usage data source may include a quantity of carbon emissions associated with the utility usage of the building management system.

The identified one or more tools each with the corresponding identified one or more arguments are executed to collect the at least some information from the one or more data sources, as indicated at block 54. The collected information along with the natural language query is submitted to a Large Language Model (such as the LLM 20), as indicated at block 56. The Large Language Model generates the response to the natural language query based at least in part on the natural language query and the information that was submitted to the Large Language Model, as indicated at block 58. In some cases, the Large Language Model collates information from various sources to generate an appropriate response to the natural language query. The response is displayed via the chatbot, as indicated at block 60.

In some cases, the method 48 may include providing a prefix prompt to the Large Language Model before submitting the collected information along with the natural language query to the Large Language Model, wherein the prefix prompt provides context for the natural language query and/or the collected information that is submitted to the Large Language Model, as indicated at block 62. Continuing on FIG. 3B, in some cases, processing the natural language query to identify the one or more tools along with the one or more arguments for each of the identified one or more tools may include submitting the natural language query to an orchestrator that is configured to identify the one or more tools along with the one or more arguments for each of the identified one or more tools, as indicated at block 64.

In some cases, the orchestrator may include a Lang Chain agent, as indicated at block 66. The Lang Chain agent may be configured to submit the natural language query to the Large Language Model prompting the Large Language Model to return one or more data descriptors, as indicated at block 66a . The Lang Chain agent may be configured to use the returned data descriptors to identify the one or more tools along with the one or more arguments for each of the identified one or more tools, as indicated at block 66b.

In some cases, processing the natural language query to identify the one or more tools along with the one or more arguments for each of the identified one or more tools may include submitting the natural language query to the Large Language Model, wherein the Large Language Model provides context for the natural language query to the orchestrator, as indicated at block 68. In some cases, processing the natural language query to identify the one or more tools along with the one or more arguments for each of the identified one or more tools may include submitting the natural language query to the Large Language Model, wherein the Large Language Model identifies the one or more tools along with the one or more arguments for each of the identified one or more tools, as indicated at block 70.

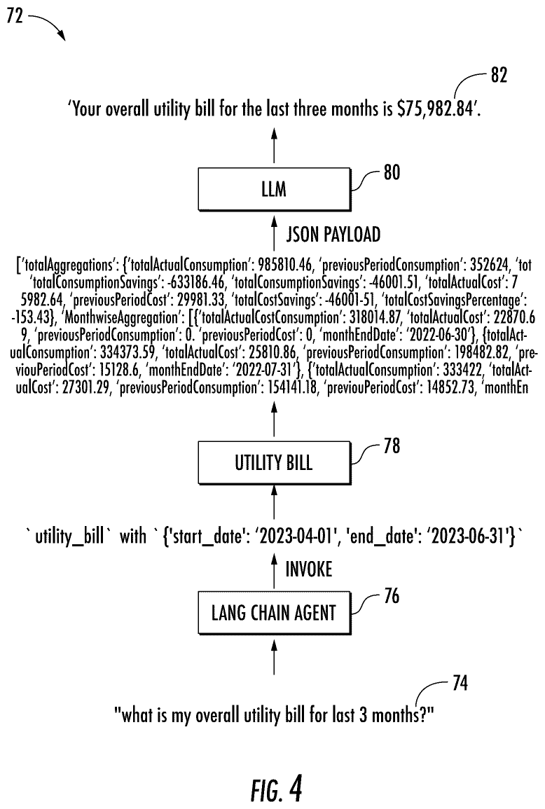

FIG. 4 is a schematic drawing 72 showing how a natural language query may be processed using the architecture of FIG. 1 or 2. In the example shown, and starting at the bottom and working upwardly, an initial query 74 is provided to a Lang Chain agent 76 (e.g. orchestrator), which processes the initial query, identifies the appropriate tool (“utility_bill” tool) from a plurality of predetermined tools, and identifies the appropriate arguments for the identified tool (e.g. the appropriate start date and end date). The identified tool 78 (“utility_bill” tool) is run, which retrieves the appropriate utility records from a utility bill database for the building via a local API, and assembles a JSON payload that includes the retrieved utility records. The JSON payload is provided to the LLM 80 (along with the initial query), which generates the plain language answer 82 “Your overall utility bill for the last three months is $75,982.84”. In this instance, the LLM analyzes data, performs numerical computation, and generates the appropriate answer to the initial natural language query.

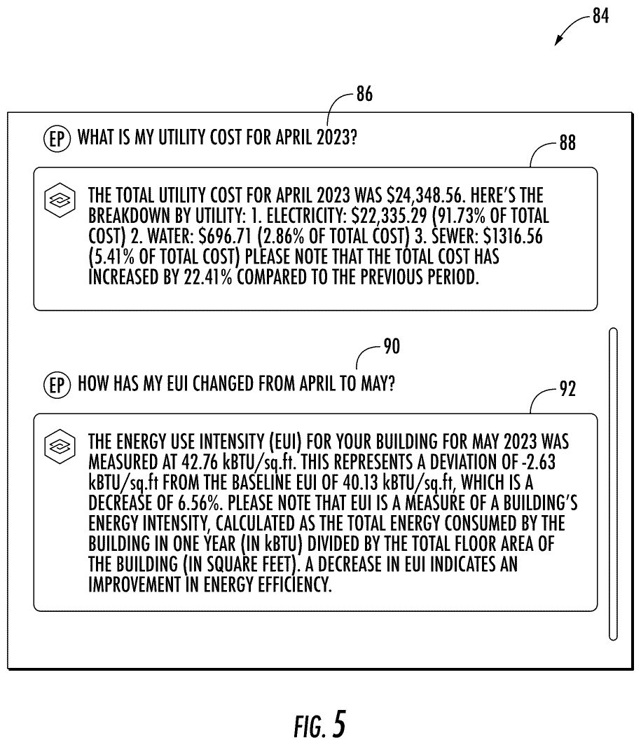

FIG. 5 is a sample screenshot 84 showing a natural language query 86 regarding April utility costs of a particular building and the corresponding natural language answer 88 that was generated by the architecture of FIGS. 1 and FIG. 2. A user has asked a follow up natural language query 90 regarding their EUI (Energy Use Intensity) and the corresponding natural language answer 92 is generated by the architecture of FIGS. 1 and 2.

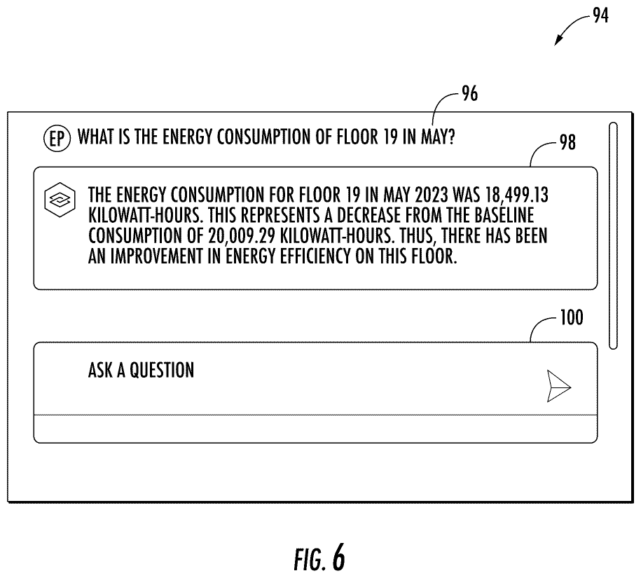

FIG. 6 is a sample screenshot 94 showing a natural language query 96 regarding energy consumption and the corresponding natural language answer 98 that was generated by the architectures of FIGS. 1 and 2. The screenshot 94 also includes a region 100 in which the user is able to type a question, such as another follow up question related to the natural language answer 98, or an unrelated question.

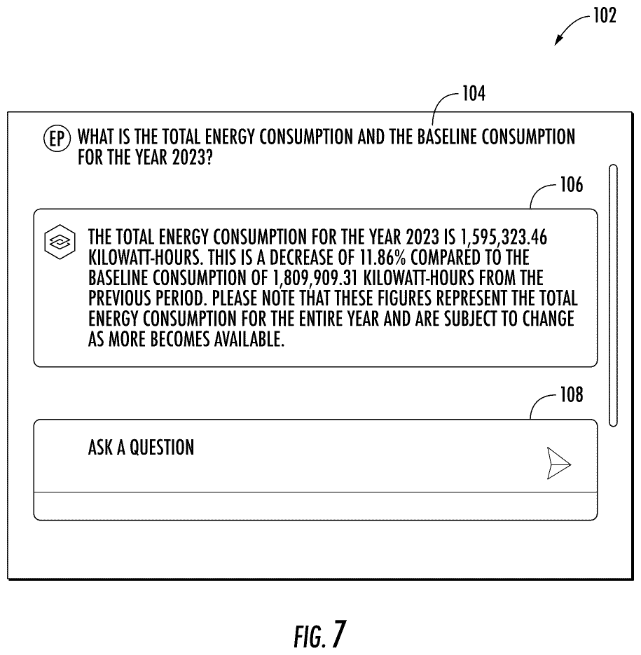

FIG. 7 is a sample screenshot 102 showing a natural language query 104 regarding energy consumption and the corresponding natural language answer 106 that was generated by the architectures of FIGS. 1 and 2. The screenshot 94 also includes a region 108 in which the user is able to type a question, such as another follow up question related to the natural language answer 106, or an unrelated question.

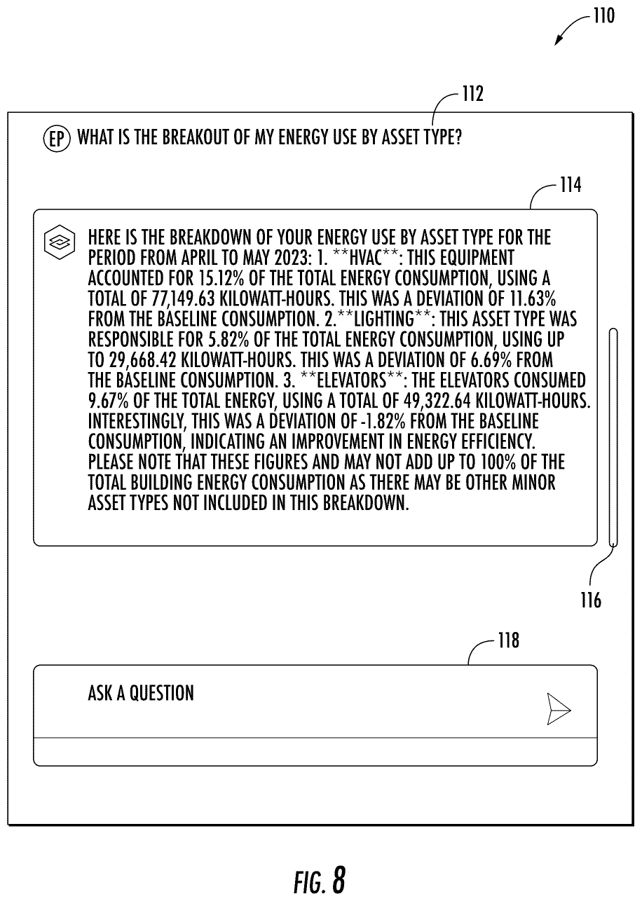

FIG. 8 is a sample screenshot 110 showing a natural language query 112 regarding a breakdown of energy consumption by asset type and the corresponding natural language answer 114 that was generated by the architectures of FIGS. 1 and 2. In some cases, a scroll bar 116 allows the user to read through answers that are longer than can be displayed in their entirety. The scroll bar 116 also allows the user to scroll up and review previous communications with the chatbot. The screenshot 110 also includes a region 118 in which the user is able to type a question, such as another follow up question related to the natural language answer 114, or an unrelated question.

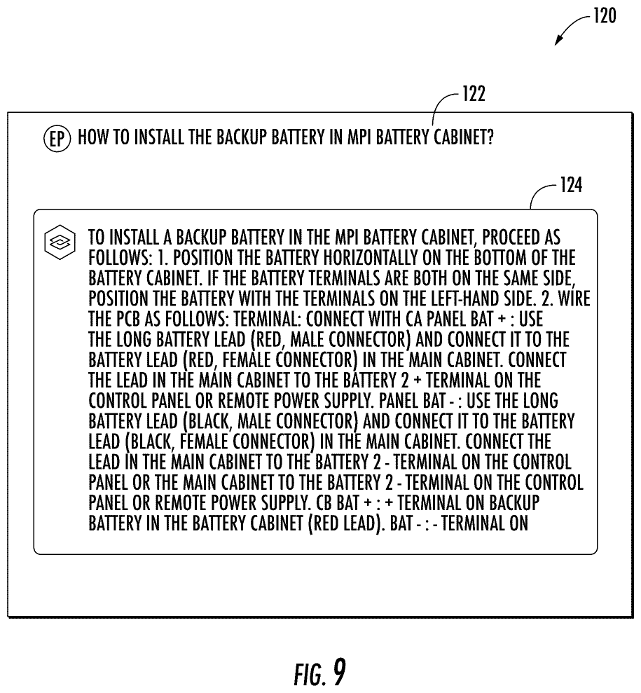

FIG. 9 is a sample screenshot 120 showing a natural language query 122 requesting battery installation instructions and the corresponding natural language answer 124 that was generated by the architectures of FIGS. 1 and 2. While not shown here, in some cases, the scroll bar 116 (shown in FIG. 7) may allow the user to read through answers that are longer than can be displayed in their entirety. The scroll bar 116 also allows the user to scroll up and review previous communications with the chatbot. If the user scrolls down, the screen may include a region in which the user is able to type another question.

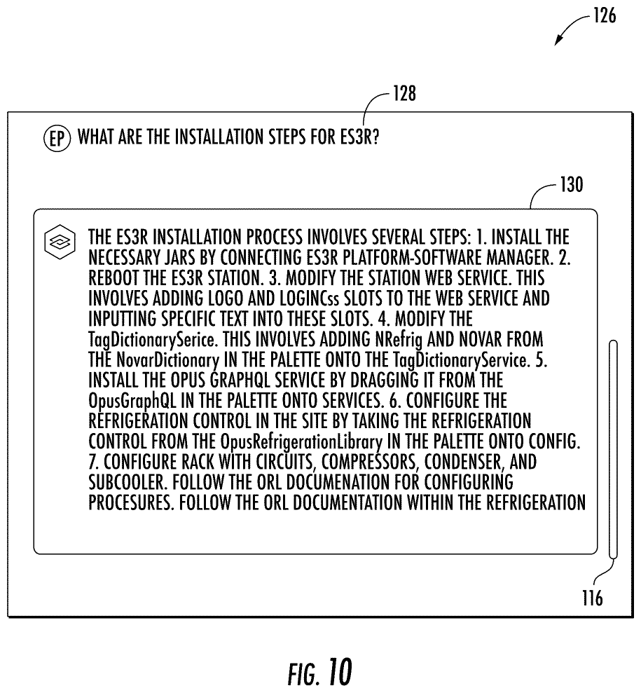

FIG. 10 is a sample screenshot 126 showing a natural language query 128 regarding environmental requirements and the corresponding natural language answer 130 that was generated by the architectures of FIGS. 1 and 2. In some cases, the scroll bar 116 allows the user to read through answers that are longer than can be displayed in their entirety. The scroll bar 116 also allows the user to scroll up and review previous communications with the chatbot. If the user scrolls down, the screen may include a region in which the user is able to type another question.

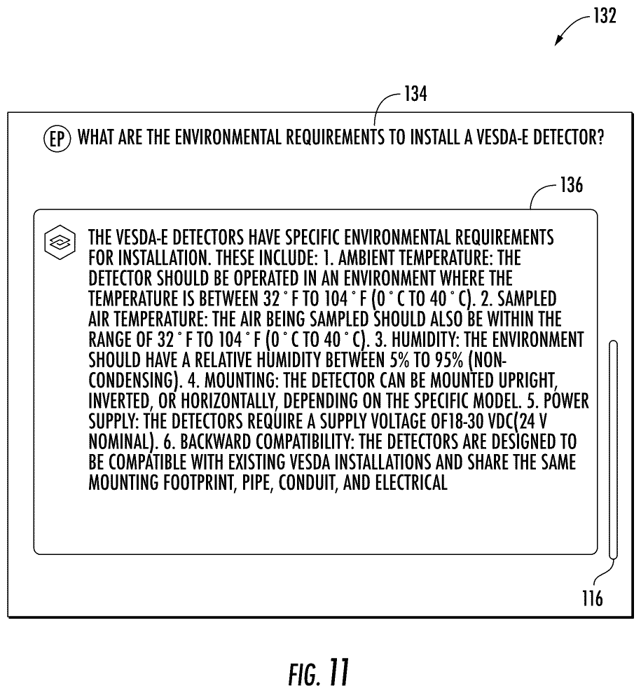

FIG. 11 is a sample screenshot 132 showing a natural language query 134 regarding environmental requirements and the corresponding natural language answer 136 that was generated by the architectures of FIGS. 1 and 2. In some cases, the scroll bar 116 allows the user to read through answers that are longer than can be displayed in their entirety. The scroll bar 116 also allows the user to scroll up and review previous communications with the chatbot. If the user scrolls down, the screen may include a region in which the user is able to type another question.

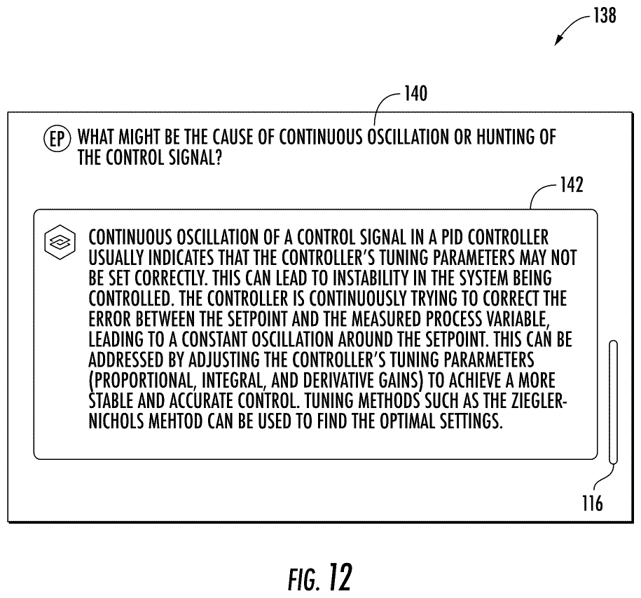

FIG. 12 is a sample screenshot 138 showing a natural language query 140 requesting battery installation instructions and the corresponding natural language answer 142 that was generated by the architectures of FIGS. 1 and 2. While not shown here, in some cases, the scroll bar 116 (shown in FIG. 7) may allow the user to read through answers that are longer than can be displayed in their entirety. The scroll bar 116 also allows the user to scroll up and review previous communications with the chatbot. If the user scrolls down, the screen may include a region in which the user is able to type another question.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for interacting with a building management system via a chatbot, the method comprising:
receiving a natural language query via the chatbot;
processing the natural language query to identify one or more tools of a plurality of available tools, along with one or more arguments for each of the identified one or more tools, for collecting at least some information from one or more data sources associated with the building management system to formulate a response to the natural language query, where each of the plurality of available tools is configured to collect only certain information from the one or more data sources dictated by the corresponding tool and the corresponding one or more arguments;
executing the identified one or more tools each with the corresponding identified one or more arguments to collect the at least some information from the one or more data sources;
submitting the collected information along with the natural language query to a Large Language Model;
the Large Language Model generating the response to the natural language query based at least in part on the natural language query and the information that was submitted to the Large Language Model; and
displaying the response via the chatbot.

2. The method of claim 1, wherein:
processing the natural language query identifies two or more tools of the plurality of available tools, along with one or more arguments for each of the identified two or more tools, and wherein the identified two or more tools are each executed with the corresponding identified one or more arguments to collect the at least some information from the one or more data sources to formulate the response to the natural language query.

3. The method of claim 1, wherein the one or more data sources comprise a utility usage data source representative of a utility usage of the building management system, wherein the plurality of available tools comprises a utility usage tool that is configured to collect utility usage information from the utility usage data source, and wherein the one or more arguments of the utility usage tool include one or more of a start data and an end date.

4. The method of claim 3, wherein the utility usage data source includes a quantity of utility usage over time and a cost associated with the utility usage.

5. The method of claim 3, wherein the utility usage data source includes a quantity of utility usage of each of two or more assets of the building management system.

6. The method of claim 3, wherein the utility usage data source includes a quantity of utility usage of each of two or more zones of the building management system.

7. The method of claim 3, wherein the utility usage data source includes a quantity of carbon emissions associated with the utility usage of the building management system.

8. The method of claim 1, comprising:
providing a prefix prompt to the Large Language Model before submitting the collected information along with the natural language query to the Large Language Model, wherein the prefix prompt provides context for the natural language query and/or the collected information that is submitted to the Large Language Model.

9. The method of claim 1, wherein processing the natural language query to identify the one or more tools along with the one or more arguments for each of the identified one or more tools includes submitting the natural language query to an orchestrator that is configured to identify the one or more tools along with the one or more arguments for each of the identified one or more tools.

10. The method of claim 9, wherein the orchestrator comprises a Lang Chain agent that is configured to:
submit the natural language query to the Large Language Model prompting the Large Language Model to return one or more data descriptors; and
using the returned data descriptors to identify the one or more tools along with the one or more arguments for each of the identified one or more tools.

11. The method of claim 9, wherein processing the natural language query to identify the one or more tools along with the one or more arguments for each of the identified one or more tools includes submitting the natural language query to the Large Language Model, wherein the Large Language Model provides context for the natural language query to the orchestrator.

12. The method of claim 9, wherein processing the natural language query to identify the one or more tools along with the one or more arguments for each of the identified one or more tools includes submitting the natural language query to the Large Language Model, wherein the Large Language Model identifies the one or more tools along with the one or more arguments for each of the identified one or more tools.

13. The method of claim 1, wherein each of the identified one or more tools include an Application Programming Interface (API) that is configured to access one or more corresponding data sources of the one or more data sources, and wherein executing the identified one or more tools includes submitting each of the corresponding identified one or more arguments to the one or more corresponding data sources via the corresponding API, and in response collecting the at least some information via the corresponding API.

14. A chatbot system for interacting with a building management system, the chatbot system comprising:
a user interface;
one or more I/O ports for communicating with one or more data sources associated with the building management system and for communicating with a Large Language Model;
a memory for storing a plurality of tools, where each of the plurality of tools is configured to collect only certain information from the one or more data sources dictated by the corresponding tool and one or more arguments;
a controller operatively coupled to the user interface, the memory and the one or more I/O ports, the controller configured to:
receive a natural language query via the user interface;
process the natural language query to identify one or more tools of the plurality of tools, along with one or more arguments for each of the identified one or more tools, for collecting at least some information from the one or more data sources associated with the building management system to formulate a response to the natural language query;
execute the identified one or more tools each with the corresponding identified one or more arguments to request and receive the at least some information from the one or more data sources via one or more of the I/O ports;
send the collected information along with the natural language query to the Large Language Model via one or more of the I/O ports;
receive from the Large Language Model via one or more of the I/O ports the response to the natural language query based at least in part on the natural language query and the information sent to the Large Language Model; and
display the response on the user interface.

15. The chatbot system of claim 14, wherein the controller is configured to process the natural language query and identify two or more tools of the plurality of tools, along with one or more arguments for each of the identified two or more tools, and wherein the identified two or more tools are each executed with the corresponding identified one or more arguments to request and receive the at least some information from the one or more data sources via one or more of the I/O ports.

16. The chatbot system of claim 14, wherein the one or more data sources comprise a utility usage data source representative of a utility usage of the building management system, wherein the plurality of tools comprises a utility usage tool that is configured to collect utility usage information from the utility usage data source, and wherein the one or more arguments of the utility usage tool include one or more of a start data and an end date.

17. The chatbot system of claim 16, wherein the utility usage data source includes one or more of:
a quantity of utility usage over time and a cost associated with the utility usage;
a quantity of utility usage of each of two or more assets of the building management system;
a quantity of utility usage of each of two or more zones of the building management system; and
a quantity of carbon emissions associated with the utility usage of the building management system.

18. The chatbot system of claim 14, wherein the controller is configured to submit the natural language query to an orchestrator that is configured to identify the one or more tools along with the one or more arguments for each of the identified one or more tools.

19. A non-transitory computer readable medium storing instructions that when executed by one or more processors causes the one or more processors to:
receive a natural language query via a user interface;
process the natural language query to identify one or more tools of a plurality of available tools, along with one or more arguments for each of the identified one or more tools, for collecting at least some information from one or more data sources associated with a building management system to formulate a response to the natural language query, where each of the plurality of available tools is configured to collect only certain information from the one or more data sources dictated by the corresponding tool and the corresponding one or more arguments;
execute the identified one or more tools each with the corresponding identified one or more arguments to collect the at least some information from the one or more data sources;
submit the collected information along with the natural language query to a Large Language Model;
receive from the Large Language Model the response to the natural language query based at least in part on the natural language query and the information submitted to the Large Language Model; and
displaying the response via the user interface.

20. The non-transitory computer readable medium of claim 19, wherein the instructions cause the one or more processors to:
process the natural language query and identify two or more tools of the plurality of available tools, along with one or more arguments for each of the identified two or more tools, and execute each of the identified two or more tools along with the corresponding identified one or more arguments to request and receive the at least some information from the one or more data sources.
